(19) United States
(12) Patent Application Publication
(10) Pub. No.: US 2006/0263186 A1
(43) Pub. Date: Nov. 23, 2006

(54) Tom cat roll back

(76) Inventor: Thomas L. Roberson, Graham, NC (US)

Correspondence Address: Thomas L. Roberson, 1725 E. Greensboro-Chapel Hill Rd, Graham, NC, 27253, US

(21) Appl. No.: 10/968,531

(22) Filed: May 8, 2005

(51) Int. Cl. B60P 1/00; B65F 1/00

(52) U.S. Cl. 414/537

(57) ABSTRACT

Composed of a frame of 4″ channel aluminum braced with 1″ square tubing along the top. Housed inside the frame, the loading ramp is composed of 2″ angle aluminum borders and center support, with 1″ square tube aluminum support braces at each end. The 8 ft ramp can be partially or fully extended for use within seconds, and returned to its housing just as quickly. Adjacent to the ramp, the lower tray is built per the same specifications and provides support and slope to aid in loading over the truck tailgate. This lower tray may be locked into position to provide a solid base for loads requiring the entire bed and tailgate area. The lower tray provides a 21″ sloped surface providing easy and smooth continuous area for loading. The ramp, tray and frame are covered with ⅛″ sheeted aluminum to provide stable loading and carrying surfaces.

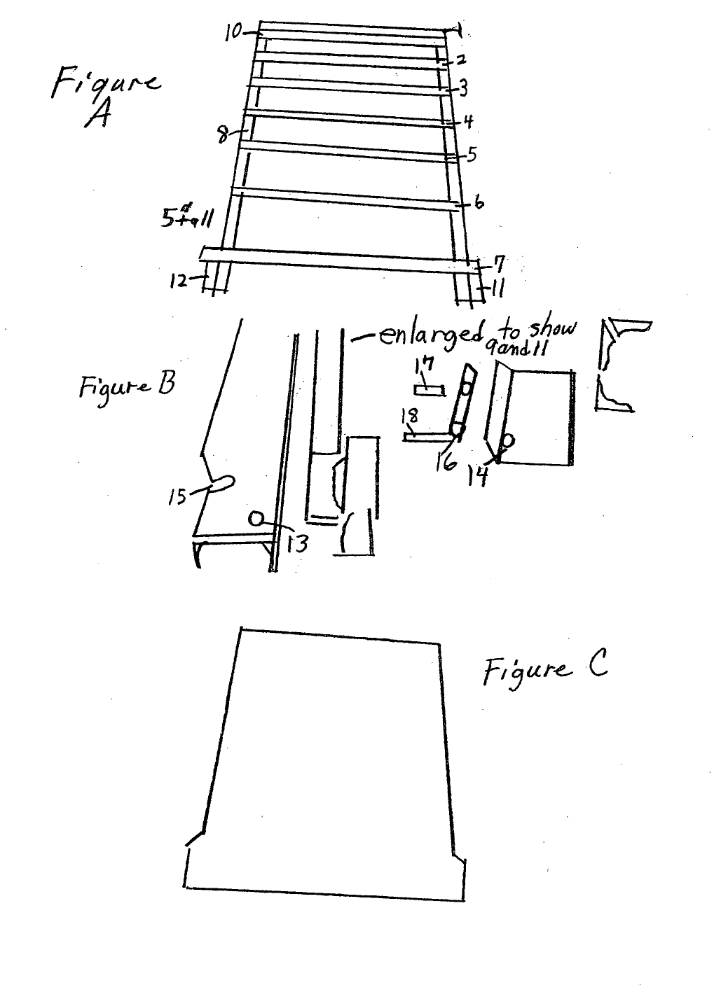

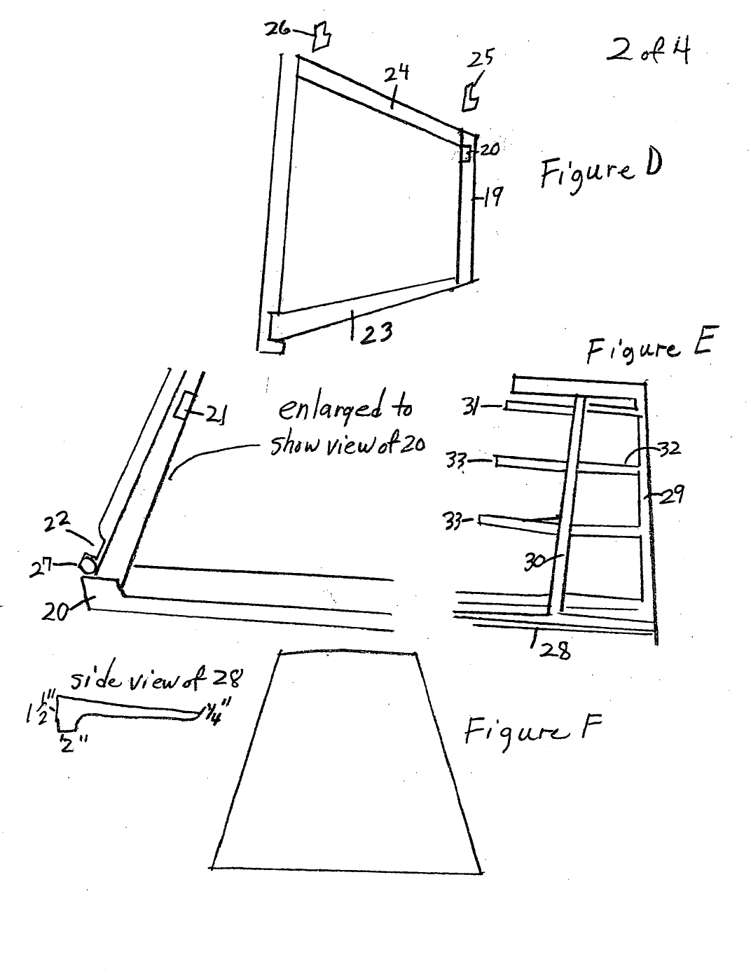

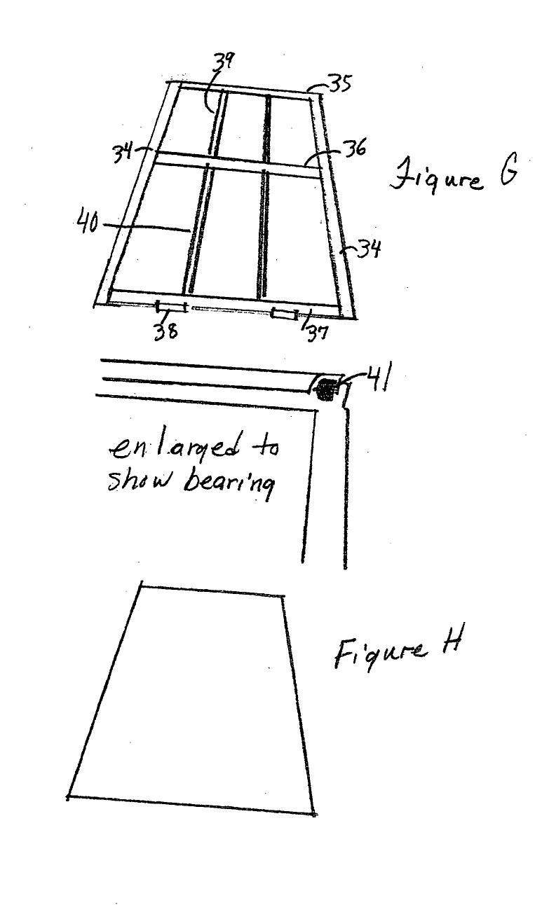

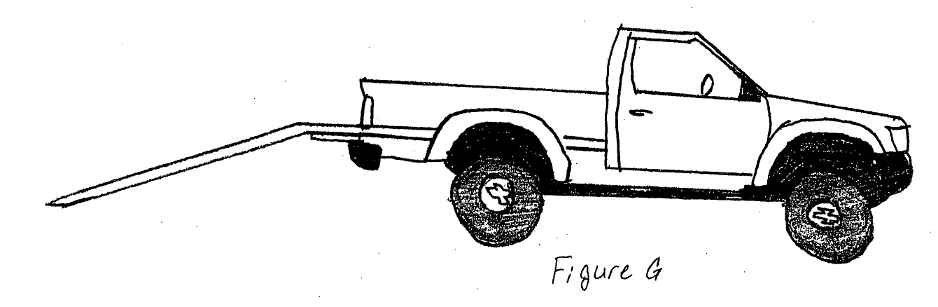

### BACKGROUND

There has long been a need for a loading option to allow pickup truck owners and drivers a safe means of loading and unloading their trucks while not obscuring the truck bed surface, and without the necessity of repetitive installation and removal of their loading ramps. The constant installation and removal of ramps to date provides ample opportunity for error and injury if they are not secured properly each time, or even if they slip or separate from the truck while in use.

The invention is positioned onto the truck bed and is secured by a brace in front of the wheel wells which prohibit its movement and holds it securely while in the truck bed. Because it is a self contained unit, there are no parts to add or position after this invention is in place. The ramp provides a continuous, stable and strong surface for loading or unloading onto the top of the frame, which in fact takes the place of the truck bed or truck liner.

### SUMMARY

This unit is housed in a frame of 4″ channel aluminum braced with 1″ square tubing along the top with a covering of ⅛″ sheeted aluminum which forms a stable “pseudo bed” surface for holding and carrying loads. Within this frame, the loading ramp is composed of 2″ angle aluminum borders and center support with 1″ square tube aluminum support braces at each end. This ramp is then covered with ⅛″ aluminum sheeting to form a solid, stable loading ramp.

Adjacent to the ramp is the lower tray. Built per the same specifications, this lower tray provides support and slope to aid in driving or loading over the tailgate portion of the truck. This lower tray may be locked into position to provide a solid and secure support base for loads requiring the entire bed and tailgate area.

This unit is then placed onto the truck bed and contains securing aluminum braces that sit in front of the wheel wells to position the invention properly in the truck bed and prohibit it from moving while in place. Once installed on a normal full size pickup truck bed, the 8 ft ramp can be fully extended for use in a matter of seconds by simply using the slots provided as handles and pulling straight out. The lower tray provides a 21″ sloped surface providing easy and smooth continuous area for loading. These sizes would differ for an extended or short bed pickup truck, but installation, security, and operation would remain constant.

After use, the ramp can be returned just as easily into its housing by lifting the ramp by its slots and sliding it back either to the position of the lower extension over the tailgate, or to its fully returned position and locked into the frame for transport or storage.

This self contained unit is composed of aluminum containing a loading ramp, which extends from a frame. The frame provides a solid complete bed surface once installed onto the truck bed. This unit is light weight enough for use in standard and compact truck beds alike. After use, and when in storage, the frame contains a locking panel door to keep the unit secure.

This panel door folds down easily once unlocked to allow access to the ramp. The ramp easily pulls out to its full length in a matter of seconds. A series of bearings and locking bars aid in the glide of the ramp and prohibit it from separating from the frame. Once positioned onto the truck bed, this invention allows for safe loading and unloading of small yard tractors, lawn mowers, motorcycles, ATV's and the like. This ramp also provides a continuous surface to case the use of manual or hand truck loading and unloading.

A completed working unit is available for inspection and testing if necessary.

### TABLE OF DRAWINGS

FIG A: FRAME

1. 1×125 Square 6063 T52 Aluminum Ext. Tube 48⅝″ Long.

2. 1×125 Square 6063 T52 Aluminum Ext. Tube 48¾″ Long.

3. 1×125 Square 6063 T52 Aluminum Ext. Tube 48 13/16″ Long.

4. 1×125 Square 6063 T52 Aluminum Ext. Tube 48 15/16″ Long.

5. 1×125 Square 6063 T52 Aluminum Ext. Tube 49″ Long.

6. 1×125 Square 6063 T52 Aluminum Ext. Tube 49⅛″ Long.

7. 1×125 Square 6063 T52 Aluminum Ext. Tube 53″ Long.

8. 4×247 6061 T6Am. Standard Ex. Channel 96″.

9. 4×47 6061 T6 Am. Standard Ex Channel 96″.

10. 4×247 6061 T6 Am. Standard Ex. Channel 48⅝″ Long.

11. Right side spacer and brace—connect to Number 9.

12. Left side spacer and brace connects to Number 8.

FIG. B: SPACER, BRACE, AND TRAY LEVER

13. ½″ Hole, center 1″ up and in.

14. ½″ Hole, center. 1″ up and in.

15. Slot curves in ¾″ wide and down 1½″

16. Lever cut 4½″ 2½″ Hole, ¾″ from each end

17. ½″ Pin 1″ long—goes through frame—lever and brace.

18. ½″ Pin 2″ long—goes through lever and frame.

19. ½″ Slot 2¼″ Long (Back).

FIG. C: Cover ⅛″×4′×8 With 2″ Dog Ears

FIG. D: BOTTOM TRAY

20. 2×2× 3/16×27″ Long 6061-T6 Aluminum angle.

21. Front ½″ Slot 2″ Long 1″ from front.

22. Slot 1″ from back 1¼″ Deep 2″ Long Rounded.

23. ¼×2 6061 T6511 Aluminum Ext. Flat 45½″ Long.

24. ½×2 6061 T6511 Aluminum Ext. Flat 48″ Long.

25. 2×2×2× 3/16 Angle Stoppers

26. 2×2×2× 3/16 Angle Stoppers.

27. Bearing 1″ Out ¼″ In.

FIG. E: TOP TRAY

28. See figure of side view

29. 1″ Square 48⅝″ long—½×2″ slot on each end.

30. 1″ Square×42⅝″ Center Brace.

31. 1″ Square×19″ (Tapered last 9″ to ¼″).

32. 1″ Square×8″

33. 10″ Long 1″ Squared Tapered to ¼″

FIG. F: Top Tray Cover 43″×21″

FIG. G: RAMP

34. 2×2× 3/16 6061 T6 Aluminum Angle 95″ Long.

35. 2×2× 3/16 6061 T6 Aluminum Angle 44″ Welded at 90 degree angle.

36. 2×2× 3/16 6061 T6 Aluminum Angle 44″ Welded at 45 degree angle.

37. 2×2× 3/16 6060 T6 Aluminum Angle 44″ Welded at 45 degree angle

38. Hand Slots 5″ Height—16″ apart.

39. 46″ Long 1″ Square—Front cut 90 degree/Back cut 25 degree.

40. 45½″ Long 1″ Square—Front cut 47 degree/Back cut 25 degree.

41. Ramp crawl bearing, Inner ⅜″ Outer 1″ on ⅜″ Stud.

FIG. H: Aluminum ramp cover

FIG. G: Side drawing of unit installed in truck with ramp extended

1. Claim is made that this unit fits onto an existing pickup truck bed securely; and provides a continuous, sturdy, and stable loading ramp that is self contained in a housing/frame which provides surface area for carrying loads so as it is not necessary to remove said unit, or add additional parts to use this unit.

2. Claim is also made that once securely installed onto the truck bed, this unit can be operated easily, safely and properly by a sole individual.

3. Claim is also made that this unit may remain on truck bed once placed there without the need of additional parts for use, and without obstruction to a hauling or carrying surface.

4. Claim is also made that this unit may remain on the truck bed, once properly installed, without the necessity of removal once the hauling is complete.

5. Claim is also made that this unit can be built for use on standard size, compact, short bed, or extended bed pickup trucks; alternative sizes an of alternative materials as necessary or requested.

6. Claim is also made that this self contained unit can be used as the basis for a pull behind type trailer loading.
